(19) United States
(12) Patent Application Publication
(10) Pub. No.: US 2016/0014953 A1
(43) Pub. Date: Jan. 21, 2016

(54) BEE BROOM APPARATUS FOR A POWER LAWN MOWER

(71) Applicants: Paul Tillman, Puyallup, WA (US); Kerm Schwartz, Puyallup, WA (US)

(72) Inventors: Paul Tillman, Puyallup, WA (US); Kerm Schwartz, Puyallup, WA (US)

(21) Appl. No.: 14/737,858

(22) Filed: Jun. 12, 2015

Related U.S. Application Data
(60) Provisional application No. 62/011,460, filed on Jun. 12, 2014.

(51) Int. Cl. A01D 34/00; A01D 34/74; A01D 34/81

(52) U.S. Cl. CPC A01D 34/001; A01D 34/81; A01D 34/74

(57) ABSTRACT

A bee repellent device for a power lawn mower having a cutting blade and a housing. The device includes a linear brush including a set of elongated head elements mounted to a front panel on the housing and positioned in substantially perpendicular relationship to a lawn. The linear brush is mounted so that its length is parallel to the front panel the elongated head elements span most or all of the front panel. The linear brush has downwardly projecting bristles secured by the set of elongated head elements, and the bristles operate to brush the surface of grasses in the lawn so as to repel bees away from the lawn mower cutting blades when the lawn mower is propelled in a forward direction.

### RELATED APPLICATIONS

This is a US Nonprovisional application claiming priority from co-pending U.S. Provisional application No. 62/011,460, entitled “Bee Broom Apparatus for a Power Lawn Mower,” filed Jun. 12, 2014, which is incorporated by reference.

### TECHNICAL FIELD

The present invention is directed to lawn mowers, and, more particularly, to a bee broom apparatus for a power lawn mower apparatus for use in saving bees.

### BACKGROUND

Healthy honey bee colonies are critical for meeting the demands of food production in the United States. A crises caused by unexplained losses of U.S. honey bee (Apis mellifera) colonies that began to be reported in 2006 as a condition named Colony Collapse Disorder (CCD) spurred the U.S. Department of Agriculture (USDA) to established a Colony Collapse Steering Committee to lead an effort to define an approach for understanding and resolving the problem.

CCD is characterized by the sudden loss of worker adults from managed hives, leading to the eventual collapse of the entire colony within a few weeks. It is a complex phenomenon, because several factors seem to be interacting to cause CCD. A 2012 document entitled “Report on the National Stakeholders Conference on Honey Bee Health,” generated by the National Honey Bee Health Stakeholder Conference Steering Committee stated as follows:
Currently, the survivorship of honey bee colonies is too low for us to be confident in our ability to meet the pollination demands of U.S. agricultural crops.
Historically, the U.S. had as many as 6 million colonies in 1947, with declines since that time to about 4 million in 1970 and 3 million in 1990. Today's colony strength is about 2.5 million.
Pollination demands have increased in recent years such that a single crop, almonds in California, now require over 60 percent of all managed colonies.
Honey bee colonies have been dying at a rate of about 30 percent per year over the past few winters which leave virtually no cushion of bees for pollination.
Because of the early almond pollination requirement, a 30 percent loss of the 2.5 million colonies would leave only 1.75 million colonies to meet the 1.5 to 1.7 million colonies currently needed in almonds. This situation leaves growers in a precarious position, and Dr. Pettis stated, ‘We are one poor weather event or high winter bee loss away from a pollination disaster.’ (Report on the National Stakeholders Conference on Honey Bee Health, USDA, 2012).

Thus any response that mitigates the destruction of honey bees is important to crop growers everywhere. The inventors herein have discovered a new and novel way to save pollinating honey bee from additional destruction due to the operation of power lawn mowers. It has been observed that bees while gathering pollen from low lying plants, such as clover, for example, they are oblivious to an approaching power lawn mower and are easily sucked up into the blades and destroyed. Thus a large number of bees are killed every lawn mowing season. No known mechanism exists for mitigating this bee carnage.

The present invention solves the need for saving honey bees from unnecessary death from lawn mowers by providing an inexpensive, reliable, stable and low cost apparatus for repelling bees in time to avoid being killed by a power lawn mower. The apparatus may be retroactively affixed to existing lawn mowers as well as built into lawn mowers at the time they are manufactured.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention provides a bee broom apparatus for a power lawn mower having a cutting blade and a housing. A linear brush includes a set of elongated head elements mounted to a front panel on the housing to create a substantially perpendicular relationship to a lawn. The linear brush is mounted so that its length is parallel to the front panel the elongated head elements span most or all of the front panel. The linear brush also has downwardly projecting bristles secured by the set of elongated head elements, and the bristles operate to brush the surface of grasses in the lawn so as to repel bees away from the lawn mower cutting blades when the lawn mower is propelled in a forward direction.

In another aspect, the lawn mower includes a blade height adjustment mechanism and the housing and bee broom are rigidly attached so that adjustment of the blade height simultaneously adjusts the bee broom height.

In another aspect, a height adjustment mechanism is coupled to the housing and the linear brush.

In another aspect, the height adjustment device includes a generally U-shaped elongated member forming a channel for accepting insertion of the front panel and having a length spanning the front panel where the outer wall of the channel is coupled to the linear brush.

In another aspect, the linear brush is adjustably coupled to the front panel with spring activated snap-in prongs.

In another aspect, a method for repelling bees away from a power lawn mower having a cutting blade and a housing is disclosed including the step of mounting a linear brush including a set of elongated head elements to a front panel on the housing to create a substantially perpendicular relationship of the linear brush to a lawn. The linear brush is mounted so that its length is parallel to the front panel the elongated head elements span most or all of the front panel. The linear brush also includes downwardly projecting bristles secured by the set of elongated head elements. The lawn mower is propelled in a forward direction so that the bristles operate to brush the surface of grasses in the lawn and repel bees away from the lawn mower cutting blades.

In another aspect, the blade height is adjusted simultaneously with the linear brush height.

In another aspect, the linear brush is adjusted using a second height adjustment mechanism coupled to the housing and the linear brush.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows an example embodiment of a bee broom apparatus for a power lawn mower apparatus.

FIG. 2 schematically shows one example of a bee broom apparatus in operation during lawn mowing and its repellent effect on a bee.

FIG. 3 schematically shows a detailed installation drawing of an example of a bee broom apparatus being installed on a lawn mower housing.

FIG. 4 schematically shows a side view of an alternative embodiment of a bee broom apparatus attached to a lawn mower housing.

FIG. 5 schematically shows a side view of an alternative embodiment of a bee broom apparatus height adjustment mechanism.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for a bee broom apparatus for repelling bees in the path of a power lawn mower. Several features of methods and apparatus in accordance with example embodiments are set forth and described in the Figures. It will be appreciated that methods and apparatus in accordance with other example embodiments can include additional procedures or features different than those shown in the Figures. Example embodiments are described herein with respect to a bee broom apparatus for a power lawn mower with a height adjustment mechanism. However, it will be understood that these examples are for the purpose of illustrating the principles, and that the invention is not so limited. Additionally, methods and apparatus in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

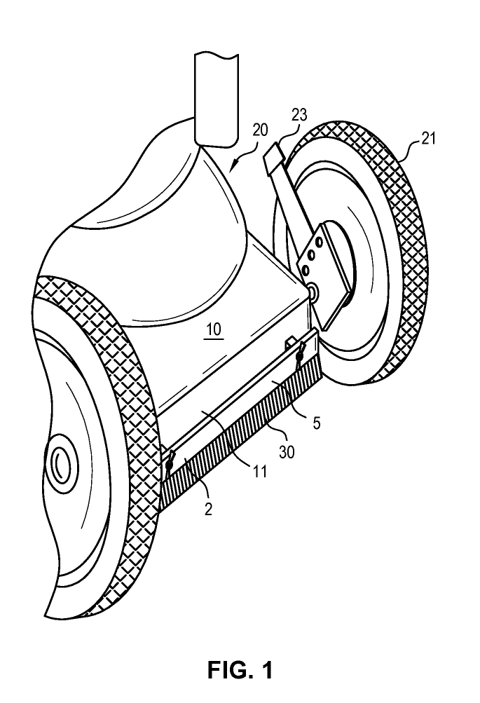

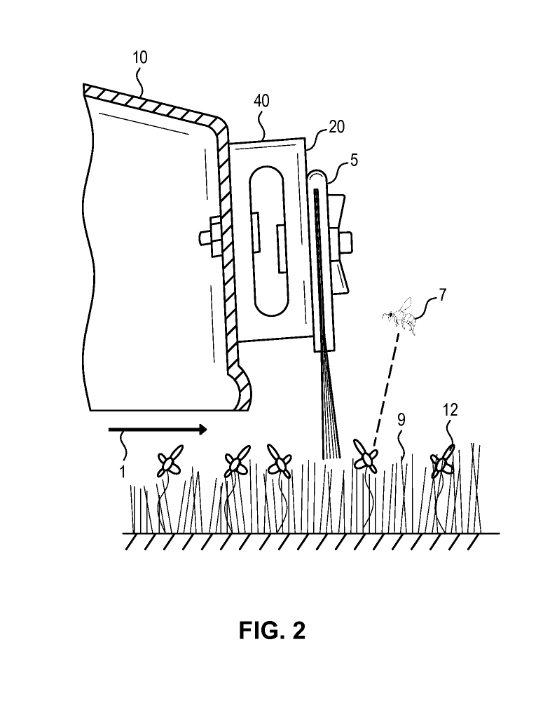

Referring now to FIG. 1, an example embodiment of a bee broom apparatus for a power lawn mower apparatus is schematically shown. A power lawn mower 20 has a cutting blade (not shown) covered by a housing 10. The lawn mower also typically includes wheels 21 and a blade height adjustment mechanism 23. A bee repellent apparatus (also called a bee broom herein) includes a linear brush 5 including an elongated head element 2 mounted to a front panel 11 on the housing 10 to create a substantially perpendicular relationship between the mounted brush bristles 30 and a lawn (as shown in FIG. 2). The linear brush 5 is mounted so that its length is parallel to the front panel 11 and the elongated head element 2 spans most or all of the front panel 11. The linear brush 5 has downwardly projecting bristles 30 secured by the an elongated head element 2, and the bristles 30 operate to brush the surface of uncut grasses in the lawn so as to repel bees away from the lawn mower cutting blades when the lawn mower is propelled in a forward direction. The housing and bee broom may be rigidly attached so that adjustment of the blade height would also simultaneously adjust the bee broom height. In one useful example, the bee broom may comprise a plurality of tightly grouped nylon bristles or equivalents clamped into a head comprising 16-18 gauge sheet metal, plastic plates or the equivalent.

Referring now to FIG. 2 one example of a bee broom apparatus in operation during lawn mowing and its repellent effect on a bee is schematically shown. Here the bee broom is shown at an advantageous height over a lawn 12 making brushing contact with a plurality of plants and grasses 9, as, for example clover, in the lawn and repelling bee 7 away from the clover and simultaneously the dangerous mower blades as the lawn mower moves in a forward direction as indicated by directional arrow 1.

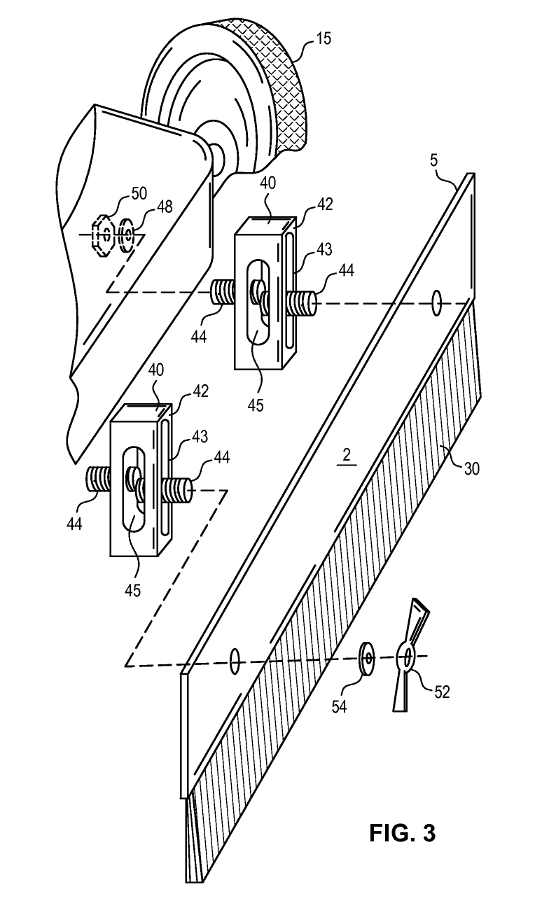

Referring now to FIG. 3, an exploded view of one example of a bee broom apparatus including one example of an optional height adjustment mechanism is schematically shown. In some cases it is advantageous to include such an optional height adjustment mechanism 40 which is additional to or supplements any blade height adjustment mechanism on the lawn mower. One example of such a height adjustment mechanism 40 includes a housing 42 having front and back side openings 43 and an insertion hole 45 for accepting a set of front and rear adjustment bolts 44 which can be inserted into the housing and have heads larger than the side openings so as to be held in place when fastened. Two or more optional height adjustment mechanisms 40 may advantageously be attached proximate the right end and left end of the linear brush 5, thereby fastening the brush to the front panel 11 of the lawn mower housing 10. Conventional fasteners may be employed such as wing nuts 52 separated by washers 54 from the head element 2 and screwed onto the front bolts 44. A similar arrangement of fasteners, such as washers 48 and nuts 50 may be located inside the housing 10 behind the front panel 11 to accept the rear bolts 44 as they pass through mounting holes 15 in the front panel.

In operation the front and rear bolts may be adjusted by loosening and tighting to raise and lower the linear brush 5. Optimally the linear brush 5 should be positioned to brush the tops of blades of grass to be mowed, although the bee broom will still work to repel bees in higher or lower positions.

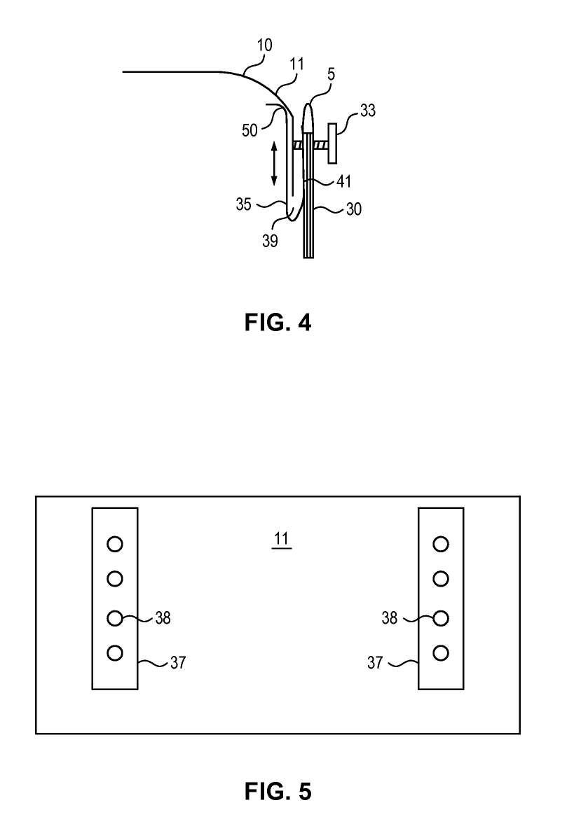

Referring now to FIG. 4 a side view of an alternative embodiment of a bee broom apparatus attached to a lawn mower housing. Here a bee broom 5 is attached by a set of fasteners 33 to an alternative eight adjustment device 35. The height adjustment device 35 may comprise a generally U-shaped elongated member forming a channel 39 for accepting insertion of the front panel 11 and having a length spanning the front panel 11 where the outer wall 41 of the channel is coupled to the linear brush 5. The top of height adjustment device 35 may be conformed to fit within the housing 10, shown here as a slightly curved end 50. By loosening and tightening the fastener 33, which may be, for example, a bolt, screw, or spring activated prong, the broom can be raised and lowered along with the height adjustment device 35.

Referring now to FIG. 5 a side view of an alternative embodiment of a bee broom apparatus height adjustment mechanism is schematically shown. Here instead of a bolt, the fasteners may be spring activated snap-in mechanisms as is well known in the art. At least two plates 37, having retention holes or detents 38 for accepting the (not shown) snap-in prongs or bolts. Other adjustment schemes well known in the art can be used to raise and lower the bee broom 5. For example, slotted brackets can be attached to the housing and the bee broom which allow adjustment of the bee broom height.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. A bee repelling apparatus for a power lawn mower having a cutting blade and a housing, the apparatus comprising:
a linear brush including a set of elongated head elements mounted to a front panel on the housing, where the brush is adapted to be positioned in a substantially perpendicular relationship to a lawn when the lawn mower is in use;
wherein the linear brush is mounted so that its length is parallel to the front panel and the elongated head elements substantially span the front panel; and
wherein the linear brush has downwardly projecting bristles secured by the set of elongated head elements, and the bristles are adapted to brush the surface of grasses in the lawn so as to repel bees away from the lawn mower cutting blades when the lawn mower is propelled in a forward direction.

2. The apparatus of claim 1 wherein the lawn mower includes a height adjustment mechanism for the blade and housing, and the housing and bee broom are rigidly attached so that adjustment of the housing height simultaneously adjusts the bee broom height.

3. The apparatus of claim 1 further comprising a height adjustment mechanism coupling the linear brush to the housing.

4. The apparatus of claim 3 wherein the height adjustment mechanism comprises a generally U-shaped elongated member forming a channel for accepting insertion of the front panel and having a length spanning the front panel where the outer wall of the channel is coupled to the linear brush.

5. The apparatus of claim 4 wherein the linear brush is adjustably coupled to the front panel with spring activated snap-in prongs.

6. A bee repellent apparatus for a power lawn mower having a cutting blade and a housing, the apparatus comprising:
a linear brush including a set of elongated head elements mounted to a front panel on the housing, where the brush is adapted to be positioned in a substantially perpendicular relationship to a lawn when the lawn mower is in use;
wherein the linear brush is mounted so that its length is parallel to the front panel the elongated head elements span most or all of the front panel;
wherein the linear brush has downwardly projecting bristles secured by the set of elongated head elements, and the bristles operate to brush the surface of grasses in the lawn so as to repel bees away from the lawn mower cutting blades when the lawn mower is propelled in a forward direction; and
wherein the lawn mower includes a first height adjustment mechanism and the housing and bee broom are rigidly attached so that adjustment of the housing height simultaneously adjusts the bee broom height.

7. The apparatus of claim 1 further comprising a second height adjustment mechanism coupling the linear brush to the housing.

8. The apparatus of claim 7 wherein the second height adjustment device comprises a generally U-shaped elongated member forming a channel for accepting insertion of the front panel and having a length spanning the front panel where the outer wall of the channel is coupled to the linear brush.

9. The apparatus of claim 8 wherein the linear brush is adjustably coupled to the front panel with spring activated snap-in prongs.

10. A method for repelling bees away from a power lawn mower having a cutting blade and a housing, the method comprising:
supplying a linear brush with a set of elongated head elements secured to downwardly projecting bristles;
connecting the head elements to span a front panel on the housing;
aligning the linear brush on the housing to create a substantially perpendicular relationship of the downwardly projecting bristles to a lawn when the mower is in use; and
propelling the lawn mower in a forward direction so that the bristles operate to brush the surface of grasses in the lawn and repel bees away from the lawn mower cutting blades.

11. The method of claim 10 further comprising adjusting the blade height simultaneously with the linear brush height.

12. The method of claim 10 further comprising adjusting the linear brush using a height adjustment mechanism coupled to the housing and the linear brush.

13. The method of claim 10 further comprising adjusting the blade height simultaneously with the linear brush height and adjusting the linear brush using a second height adjustment mechanism coupled to the housing and the linear brush.

14. The method of claim 13 wherein the second height adjustment device comprises a generally U-shaped elongated member forming a channel for accepting insertion of the front panel and having a length spanning the front panel where the outer wall of the channel is coupled to the linear brush.

15. The method of claim 13 wherein connecting the head elements comprises adjustably coupling the linear brush to the front panel with spring activated snap-in prongs.

16. The apparatus of claim 1 wherein the lawn mower further comprises:
a first height adjustment mechanism for the blade and housing, and the housing and bee broom are rigidly attached so that adjustment of the housing height simultaneously adjusts the bee broom height; and
a second height adjustment mechanism coupling the linear brush to the housing.

17. The apparatus of claim 16 wherein the second height adjustment mechanism comprises a generally U-shaped elongated member forming a channel for accepting insertion of the front panel and having a length spanning the front panel where the outer wall of the channel is coupled to the linear brush.

18. The apparatus of claim 16 wherein the linear brush is adjustably coupled to the front panel with spring activated snap-in prongs.

19. The apparatus of claim 1 wherein the linear brush is adjustably coupled to the front panel with spring activated snap-in prongs.

20. The apparatus of claim 1 further comprising a generally U-shaped elongated member forming a channel for accepting insertion of the front panel and having a length spanning the front panel where the outer wall of the channel is coupled to the linear brush.
